(19) United States
(12) Patent Application Publication
(10) Pub. No.: US 2009/0125442 A1
(43) Pub. Date: May 14, 2009

(54) Wireless communications device configured for automated returns

(76) Inventors: Jonathan Otto, Palm Beach, FL (US); Michael R. Mueller, San Francisco, CA (US); Andrew Van Luchene, Santa Fe, NM (US)

Correspondence Address: SIMPSON & SIMPSON, PLLC, 5555 MAIN STREET, WILLIAMSVILLE, NY, 14221-5406, US

(21) Appl. No.: 11/983,680

(22) Filed: Nov. 9, 2007

(51) Int. Cl. G06Q 20/00; G08B 13/14

(52) U.S. Cl. 705/39; 340/572.1

(57) ABSTRACT

A method for automated return of an item, including the steps of: automatically identifying, with a processor and an interface element in a specially programmed general-purpose computer, an item brought within a predetermined proximity of a retail location operated by a business entity; determining, via the processor and a memory element in the general-purpose computer, that the item was previously purchased from the business entity by a customer; and applying, using the processor, a credit for the item to an account associated with the customer. In some aspects, the item comprises an RFID tag and the memory element comprises a sales record for the item including data regarding the tag, and automatically identifying an item includes automatically detecting the tag and transmitting data identifying the tag to the interface element, and determining that the item was previously purchased includes using the data identifying the tag to select the sales record.

### CROSS-REFERENCE TO RELATED APPLICATIONS

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to methods and systems for automating the return of a previously purchased item to a retail location.

### BACKGROUND OF THE INVENTION

Currently, retail sales locations can offer an extremely wide variety of choices to consumers. For example, Wal-Mart, the world's largest retailer, offers literally thousands of items to its customers at any one location. This variety and volume of items provides consumers with a wide number of options, while tending to drive prices lower and lower. Buying and selling at such high volumes has obvious benefits for the retailer as well. Such retail locations typically permit end users (i.e., customers) to return items to the store if the end users purchased the wrong item or for other acceptable reasons. Unfortunately, the return areas of stores are typically quite crowed and it may take an unacceptable amount of time for an end user to return an item at the return area.

Thus, there is a long-felt need to provide a system and method with which customers of a retail entities could quickly and easily return items at retail locations for the retail entities without having to use existing processes, such as return areas or desks. Specifically, the system and method should enable quick and easy return of items with minimal contact with retail personnel.

### SUMMARY OF THE INVENTION

The present invention broadly comprises a method for automated return of an item, including the steps of: automatically identifying, with a processor and an interface element in a specially programmed general-purpose computer, an item brought within a predetermined proximity of a retail location operated by a business entity; determining, via the processor and a memory element in the general-purpose computer, that the item was previously purchased from the business entity by a customer; and applying, using the processor, a credit for the item to an account associated with the customer. In some aspects, the item includes a radio frequency identification (RFID) tag and the memory element includes a sales record for the item including data regarding the RFID tag, and automatically identifying an item includes automatically detecting the RFID tag and transmitting data identifying the RFID tag to the interface element, and determining that the item was previously purchased includes using the data identifying the RFID tag to select the sales record.

In some aspects, the memory element includes a sales record for the item including data regarding a wireless communications device associated with the customer and automatically identifying an item includes: detecting the wireless communications device within the predetermined proximity of the retail location; identifying the wireless communications device; obtaining, with the wireless communications device, data identifying the item; and receiving in the interface element, the data identifying the item, and determining that the item was previously purchased includes using the data identifying the item to select the sales record. In some aspects, the wireless communications device includes a means for detecting an RFID tag or a bar code, the item includes an RFID tag or a bar code, and obtaining, with the wireless communications device, data identifying the item includes detecting the RFID tag or scanning the bar code using the means for detecting an RFID tag or a bar code. In some aspects, applying a credit includes applying the credit to an account for the wireless communications device.

In some aspects, the customer has a membership with a loyalty program or a marketing program and applying a credit includes applying the credit to an account associated with the membership. In some aspects, applying a credit includes withholding the credit until a satisfactory condition of the item is confirmed. In some aspects, the item includes an RFID tag and confirming a satisfactory condition of the item includes automatically determining a condition of the RFID tag. In some aspects, the item includes an anti-theft element and confirming a satisfactory condition of the item includes automatically evaluating the anti-theft element.

In some aspects, the credit includes a value and the method includes: at the retail location, automatically identifying, using the interface element, the processor, and the memory element, a replacement item, the replacement item having a cost; and applying, using the processor, the value against the cost. In some aspects, a wireless communications device associated with the customer and the replacement item each includes an RFID tag or a bar code and automatically identifying a replacement item includes, detecting the RFID tag or the bar code for the wireless communications device and the replacement item with a self-service device in the retail location. In some aspects, a wireless communications device associated with the customer includes a means for detecting an RFID tag or a bar code, the replacement item includes an RFID tag or a bar code, and automatically identifying a replacement item includes, detecting the RFID tag or the bar code for the replacement item with the wireless communications device. In some aspects, the cost exceeds the value by an amount and the method includes charging, using the processor, the amount to the account.

In some aspects, the method includes compiling, using the processor and the memory element, a transaction history for the customer, the transaction history includes data regarding items previously returned by the customer and applying a credit includes applying the credit responsive to the transaction history.

The present invention also broadly comprises a system for automated return of an item.

It is a general object of the present invention to provide a system and method to enable a customer at a retail location to quickly and easily return an item at the retail location.

It is another object of the present invention to provide a system and method to enable a customer at a retail location to quickly and easily return an item at the retail location with little or no interaction with personnel at the retail location.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention system for automated return of an item; and,

FIG. 2 is a flow chart of a present invention method for automated return of an item.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

The following non-limiting definitions are applicable to the present invention:

Business—includes any business enterprise formed for the purpose of providing a product or service, which may or may not be for profit.

Business Objective—includes any desired outcome of a business or business owner, including, for example, acquisition of new customers, delivery of one or more marketing offers, increases or improvements in product quality or service, sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Business Information—includes any information that is provided, known, gathered, assumed or is otherwise determined or stored that is related to or is about or otherwise helps understand, define, operate, improve, track or report the performance of, a business, for example, customer acquisition and sales data, marketing information, click-through rates, conversion rates, profit and loss information, accounting information, financial information, statistics and ratios, customer information, sponsor information, information about any one or more business, customer or sponsor objectives, or any other information, business metrics and data gathered or stored or otherwise possessed or accessible by a business and/or any of its affiliates, sponsors, customers or investors.

Controller—means any one or more of the following electronic devices including, but not limited to: cell phones, Personal Digital Assistants or (PDA's), Blackberry or similar devices, such as hand held computers, MP3 players, or any other personal electronic device that has one or more of a keyboard, speaker, microphone, one or more buttons, or any other similar devices that provides a User with Input and/or Output Functionality and Remote Connectivity. A Controller may be or include one or more of a Display and/or a Server or other computing devices or means of computing.

Customer Facing Display—includes any device accessible by an end user or customer that includes at least one of a display, input means, e.g., a touch screen or keyboard, or other output means, e.g., a speaker. In certain embodiments, a Customer Facing Display may include a Kiosk, POS Terminal, or other computing device, such as a cell phone, PDA, laptop or PC. In certain embodiments a customer facing display may be a POS or POS terminal and vice versa.

Customer Identifier—includes, but is not limited to a cell phone, an RFID tag, a credit card, a debit card, a frequent shopper card or number, a coupon, a license plate, a check, a loyalty or gift card, fingerprint or other biometric input, a driver's license, or other identification means.

Customer Information—includes any information that is provided, known, gathered, assumed or is otherwise determined or stored that is related to or is about or otherwise helps understand or define a customer and/or a customer's buying habits, preferences or tendencies. Such information may include the customer's (or any related person, e.g., a child) order history, order contents, ideal order acceptance or rejection data, willingness to accept or reject one or more marketing offers or messages (either specific or types or categories of offers), price point or price elasticity, tendency to attempt to game other otherwise attempt to take advantage of the system or marketing program, average order total, e.g., average check, average item count, e.g., average number of items in a given order, average customer count, e.g., how many persons in the party on average, any demographic information, e.g., income, race, mailing address, zip codes, phone numbers, household total income, number of children, age, sex, number and type of internet enabled devices, participation in one or more marketing programs, willingness to use kiosks, cell phones or other ordering devices, prior ordering history, including willingness or tendency to accept pre, mid and/or post order marketing offers, e.g., suggestive selling, cross selling, sponsor rewards, or any other offers, and/or any other information gathered or provided by/from the customer, e.g., preferences information gathered by observing such customer behavior, e.g., does customer switch from cold beverages to hot beverages in the wintertime, and/or information gathered or supplied by a marketing program and/or by such customer when signing up or otherwise maintaining such information in a customer loyalty or other marketing program's database, or by importing or otherwise accessing information about such customer via any public or commercially accessible database and/or any combination of the foregoing information.

Customer Objective—includes any desired outcome, behavior that benefits a customer, including, for example, improved or better pricing, service, e.g., friendly service, speed of service, accuracy of service, quality of delivered products, types of marketing offers and/or savings associated with each, cleanliness of location, type of online or other ordering systems, including, e.g., POS devices, or any other favorable treatment or benefit that can be obtain or otherwise accrues to the benefit of such customer, and/or any combination of the foregoing.

Dilution—includes any outcome that has a net negative effect, e.g., an acceptance of an upsell or other offer results in providing a discount on an item, which a customer might otherwise have paid full price.

Discount—includes any price or offer at an amount other than the standard list price or expected price or shelf price, or displayed price, e.g., online.

Display—includes any one or more of the following electronic devices including, but not limited to: TV (of any technology type, including but not limited to a Plasma Display, LCD, CRT or DLP), Kiosk, LED display, Electronic Shelf Label, Automated Teller Machine (ATM), POS terminal, video game display, video slot machine or other video based casino games, speaker, or any other device capable of displaying, presenting or otherwise outputting or processing Output Materials (such as an LCD or other display in an airline seatback or other Location, e.g., a grocery cart equipped with a display and/or a bar code or RFID printer or reader), including devices that provide a User with Output Functionality. A Display may include or be one or more of a Controller and/or a Server and/or other computing device capable of providing Input and/or Output Functionality and/or Remote Connectivity.

Domain Name Server (DNS)—One or more computers including a cooperatively run set of databases, distributed among several servers, volunteered as repositories for IP address information.

End User—includes any person or entity making use of any one or more of the methods of the disclosed invention, and/or any system that uses or is based upon or benefits from one or more of the disclosed inventions, including, for example, customers, vendors, retailers, QSR operators, managers, employees, supervisors, friends, family members, or any other person as applicable to the given context or otherwise.

Existing Member—includes a member of a loyalty program or other marketing program and/or a person that has signed up for any marketing or other program and/or has provided information to such a program, whether or not such person is aware of such program, including, end users.

Frequent Shopper Program—includes any system that provides one or more rewards to members of such program for purchases made.

Frequency Program—includes any Frequent Shopper Program or other rewards system that rewards customers for their frequency of visit and/or buying one or more products, goods or services.

GUI—includes a graphical user interface, or other means of providing communications from or to an end user, including via graphics, text, audio, video, data input, such as voice, typing, touch screen, or other means of input or output to/from any device, including a POS Terminal, or other computing devices. Such GUI may include information and/or actions that are available for viewing, use or interaction with an end user. Such interaction may be accomplished via any applicable means, including, for example, manipulating icons, widgets or other items or areas displayed on such GUI, including, clicking on one or more hyperlinks, and/or entering information into fields or other areas designed for such purposes, e.g., typing a name, or selecting one or more items from a displayed list, etc.

Header—A numeric code assigned to a request for content by either a LAN or ISP Server, which identifies a requestor's unique Internet Protocol Address. Generally, the Header is used for purposes of accurately returning a requested Mark-up Language-based electronic document as well as any corresponding files to the requestor.

Hyperlink—A text phrase or graphic embedded within a markup language-based electronic file, which corresponds to the address of a site on the World Wide Web.

Input Functionality—includes any one or more of any of the following, including but is not limited to any device that includes or provides one or more buttons (e.g., a keyboard) that can convey individual or grouped electrical signals, impulses, commands, or messages, or other tactile or other input device including a joy stick, mouse, touch screen, and/or audio (e.g., voice commands or instructions), bar code scanner, RFID reader, fingerprint or other biometric scanning device, scale, laser pointer, camera, infrared sensor, cell phone, hand held computer or PDA keypad, motion or other “presence” detector, magnetic card or magnetic card reader, and any other input method recognizable by or able to convey information to any one or more of a Display, Server, Controller or other computing device.

Internet—includes the world wide web and the network that is accessible by the public that includes a network of interconnected computers that transmit data using, for example, Internet Protocol (IP). In some aspects, certain private networks, including virtual private networks (VPN) may be included in the definition of the Internet.

Internet Device or Internet Enabled Device—includes any computing device that is capable of accessing or otherwise communicating with or via the Internet or any other network, client/server and/or peer-to-peer or any other network, and/or that is otherwise able to practice or benefit from any one or more of the herein disclosed inventions.

Internet Ordering or Online Purchase—includes the processing, in whole or in part, of any one or more transactions using or otherwise communicating via the Internet or other means of communications by or between any one or more of a business, sponsor and/or one or more customers, which transaction may be for or include the purchase, trade or acquisition of one or more items. In certain embodiments, internet ordering or online purchases may include the delivery of one or more marketing messages or marketing offers.

Item—includes any object, tangible or intangible, which may include any item for sale, rental, lease, consumption, transfer, and/or may be possessed or owned. Item may include any physical or virtual object. In certain embodiments an item may be any one or more of a food item, a beverage item, a dessert item, a retail good, a food product, a device, a POS device, a coupon, clothing, furnishings, groceries, automobiles, motorcycles, lighting, electrical equipment or devices, etc.

Kiosk—includes any device or location that permits a customer or end user to enter part or all of an order and/or respond to a marketing message or offer, with or without the assistance of a third party, e.g., a cashier. Kiosks may include software to prevent end users from performing unauthorized actions and/or accessing the system, operating system or other secure areas of the kiosk and/or systems to which it may be attached or connected, e.g., the Internet or one or more servers, etc.

Location—means and includes, but is not limited to retail stores, restaurants, bars, theme parks, casinos, video game parlors, Internet Café's, coffee bars, book stores, gas stations, convenience stores, hotel rooms, hotel or other lobbies, meeting rooms, office buildings, offices, airports, airplanes, government or other public services buildings, hospitals or any other public or private area or facility or residence that contains, possesses or otherwise provides limited or general access to at least one Display and/or practices part or all of any one or more embodiments of the present invention.

Loyalty or Frequent Shopper Member—includes any end user or person that has joined or signed up or opted into a loyalty program and/or frequent shopper program.

Loyalty Member—a person that has signed up for or otherwise participates in a loyalty or frequent shopper program.

Loyalty Program—any system that permits users to sign up to receive rewards based upon such user's purchases or visitation frequency.

Marketing Message—Includes a marketing offer, or any other communication with an end user, e.g., a customer, which message may include any one or more of the following such as, any one or more of a graphic, logo, icon, price, discount or other offer, video, audio, or other visual, audio or static marketing or other content designed to communicate with or otherwise inform, educate or persuade a User. In certain embodiments, a marketing message may include one or more marketing offers.

Marketing Offer or Offer—includes any offer for sale of any item, good, product or service.

Marketing Program—includes any system that provides marketing messages, marketing content, loyalty programs, coupons, discounts, or any other offers or marketing offers, and/or tracks customer buying habits and other information, including customer information, such as locations, travels, demographics, ordering preferences, etc.

Markup Language—A set of codes in a text file that instructs a computer how to format the file for purposes of printing and/or display, as well as how to index and link the content of the file. Example markup languages include HTML, SGML, XML, VRML, and NRML.

Network Device—includes any device that can be interfaced with a technology network, for example, the Internet, a wireless communications network, (e.g., a cellular telephone system), a LAN, or a WAN.

Optimized—includes determining which marketing offer will likely or generally achieve the desired results or maximum results among or given one or more of several complimentary or competing objectives, including, for example, sales volume, gross margin, profits, customer accept rates, average check, speed of service times, product quality, freshness, customer satisfaction, customer frequency, order point, destination point or any other variables that affect or are of interest to one or more affected parties, e.g., the retail establishment, its suppliers and/or the customer. In certain embodiments, optimized includes finding the maxima or minima of a given function. In certain embodiments, the terms optimized and optimal have corollary meanings.

Output Functionality—includes transmission of information via Remote Connectivity and/or conveying Output Materials on a Display and/or tactile feedback.

Output Materials means any one or more of the following, including but is not limited to any one or more of, Marketing Messages, audio, still images and/or video, flash and/or other animated sequences or materials, printed or visual reports or receipts, displayed information, information recorded to or stored on a hard drive or other computer readable medium, a text message, voice mail message, a sound such as a beep or bell or buzzer, audio messages (e.g. a voice prompt or marketing message or other information), including recorded, actual or synthetic voice messages, or any other output generated by a Display, Server, Controller, Network or other device or application that is sent to or processed by a User, Display, Server, Controller, Network or other device for subsequent viewing, listening and/or further processing or storage.

PC—includes a personal computer, such as a laptop, such as one provided by Dell Computers.

PDA—includes a personal digital assistant, such as Palm Pilot, or any other personal computing device, which includes at least one of a display, processor, memory or input or output means.

Point of Sale—includes any Point of Sale system or device that permits an end user to start, enter or complete an order or sales transaction, such as Panasonic's 7900 “all in one”, or any other POS devices, terminals or systems, websites, kiosks, PCs, PDAs, Cell Phones, call centers, slot machines, vending machines, and/or any other Internet or other device that provides access to any of the functionality or inventions disclosed herein and or any of the same or similar functionality and/or otherwise permits an end user to practice or benefit from any of the disclosed inventions. Point of Sale and POS shall have corollary meanings.

POS Device, includes a POS or other physical device that provides access to any of the features or inventions disclosed herein and or any of the same or similar functionality and/or otherwise permits an end user to practice or benefit from any of the disclosed inventions.

POS Terminal—includes a POS or other physical device that provides access to any of the foregoing and or any of the same or similar functionality and/or otherwise permits an end user to practice or benefit from any of the disclosed inventions.

Product—includes any machine, manufacture and/or composition of matter, unless expressly specified otherwise.

Prospective Member—includes any person that is not currently a member.

Referral—includes any prospective member identified or otherwise provided by an existing member.

Proximal, Proximity, Proximal/Proximity Data—includes any information about an end User's current or predicted whereabouts. Such information may include distance, i.e., distance between two points, e.g., a retail location and the end user, which distance may be measured directly, e.g., point A to point B, or based upon travel means, e.g., based upon the streets or other paths that a person or end user could actually use to travel from said point A to said point B, and/or may be based upon time, e.g., how long it might take a given end user to travel said distance between point A and point B, perhaps further as determined by such end user's current rate of travel or average rate of travel or method of travel, etc. Methods to calculate distances between to points in space and/or to estimate travel time are well known by those of ordinary skill in the art.

Response—includes any action and/or failure to act by any person. For example, a response from a prospective member includes the immediate or subsequent reply to or use of one or more marketing messages or offers or other response, which response includes, but is not limited to, for example, signing up to one or more loyalty, frequency or other marketing programs, acceptance and/or use, e.g., redemption, of any one or more offers or coupon, opting in to one or more loyalty, frequency or other marketing program(s), achieving or maintaining a certain level of sales and/or number or frequency of store visits, purchases of certain products, providing one or more email addresses, visiting one or more retail, restaurant or other store location(s), ordering one or more items, or specific items, or failure to order one or more items or specific items, filling out a form or forms, or providing additional information, such as mailing address, phone number, internet device id information, and/or signing up for one or more third party sponsor programs, and/or any other action as determined or established by the marketing program, pressing one or more buttons and/or clicking on one or more hyperlinks or any combination of the foregoing. The terms response and respond shall have corollary meanings.

Reports—in certain of the disclosed embodiments, one or more reports may be developed to provide tracking and/or analysis relating to any one or more data elements associated with any such embodiment or invention. Reports include any feedback or communication requested by or delivered to one or more end users, which may or may not require authorization to receive such report. Reports can be printed, verbalized using a text to speech conversion program, or displayed on any device, including, for example, a POS terminal or other computing device. Such reports may be created and/or delivered using any applicable means available. The methods to create and deliver reports are well understood and known within the industry and are disclosed in the prior art. Reports may be demand request, i.e., a report is generated only when or as requested, or exception based, i.e., a report is generated if a certain condition or conditions are met, not met or change in any defined way. In certain embodiments, reports are generated whenever desired or otherwise indicated or scheduled, and may be stored for subsequent use, which use may or may not be based on a request by an end user. Reports may include any one or more available database elements and/or calculated results based upon any one or more of the databases, database elements, mathematical or statistical manipulations, and/or any of the methods disclosed herein and/or as understood by any person skilled in the art and/or as requested/designed by one or more end users or other authorized personnel. For example, a report may include any one or more pieces of information contained or relating to customer, business or sponsor information, and/or POS transaction data and/or any or all results information generated or associated with any marketing offer or message.

Reward—includes any item or object or incentive that is or might be of benefit to its recipient, for example, a free or discounted item or a financial incentive, presented to an end user, e.g., an existing loyalty or marketing program member. In certain embodiments, rewards may be provided without any action of or by the recipient to receive such reward. In other embodiments, recipients must perform certain actions, e.g., purchase items from a business, or make a commitment to make such purchases, in order to receive, earn or otherwise qualify for any such reward(s). In some embodiments, a reward may be cash or an offer of cash or other financial currency or benefit. In certain embodiments, a reward may be an item, such as a toy, or a coupon. In yet other embodiments, a reward may be a combination of any or all of the foregoing. In certain embodiments, rewards may be created, funded or otherwise provided by businesses or sponsors. Rewards may be offered and/or delivered using any applicable means, including electronic transmission via the Internet, cell phones, text or voice mail, and may include one or more marketing messages or marketing offers. Rewards may be issued, granted or provided by individuals or groups and/or delivered or provided to individuals or groups. In certain embodiments, recipients of one or more rewards may be required to perform a certain task or tasks to qualify and/or to make use of one or more rewards. In some embodiments, rewards may be used only by the specific individual(s) who received the reward. In addition or in the alternate, rewards may be transferable or do not specify the recipient or require that only the recipient may benefit from such reward(s). In some embodiments a coupon may be a reward and/or a reward may be a coupon.

Viral Reward—includes any reward, coupon or other incentive designed to encourage additional use of such reward and/or to encourage one or more additional persons to join a loyalty or marketing program and/or to help achieve any other business, sponsor or customer objective(s). In some embodiments, viral rewards may be communicated via any applicable means, including, for example, via email, voice mail or text based messaging services. The terms viral reward, network reward, viral coupon, and network coupon shall have corollary meanings.

RFID—includes a radio frequency identification tag, transponder or similar devices.

Router—An intermediary device within a communications network that expedites message delivery. Within a single network linking many computers through several possible connections, a router receives transmitted messages and forwards them to their correct destination via an efficient available route.

Sensor—includes any application or device that can make a determination or otherwise detecting the change, presence or absence of something, including, for example, temperature, weight, sound, pressure, volume, mass, light, odors, and/or any recording, or registration, change, presence or absence of or to any data or other electronic media. In certain embodiments a sensor includes one or more transducers.

Sponsor—includes any third party or entity that provides product, goods or services and/or money or other financial means to an end user or retail entity in exchange for the option to communicate with such end user, including, for example, to provide one or more marketing messages or offers, including, e.g., a cross sell offer or sponsor reward.

Store—includes any one or more retail, restaurant or other location, and may include online locations, websites, kiosks, automated stores, e.g., vending machines, so called “brick and mortar” locations, and/or any combination of the foregoing, and/or access to any such location(s) using any POS device.

Sponsor Information—includes any information that is provided, known, gathered, assumed or is otherwise determined or stored that is related to or is about or otherwise helps understand, define, operate, improve, track or report the performance of, a sponsor business, for example, customer acquisition and sales data, marketing information, click-through rates, conversion rates, profit and loss information, accounting information, financial information, statistics and ratios, customer information, sponsor information, information about any one or more sponsor objectives, or any other information, business metrics and data and/or business information gathered or stored or otherwise possessed or accessible by a sponsor and/or any of its affiliates, businesses, customers or investors.

Sponsor Objective—includes any desired outcome of a sponsor or sponsor business owner, including, for example, acquisition of new customers, conversion of competitor's customers to sponsor's customers, delivery of one or more marketing messages or offers, increases or improvements in sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Subscription—includes an agreement, which may be implicit or explicit, to purchase a certain quantity of goods, services, products or items and/or purchase the rights to use or access such goods, services, products or items, during or over a specified period of time, and/or an agreement to spend a certain amount of money over a certain period. In certain embodiments, subscriptions may be accepted through an action or failure to act by a subscriber or end user. In certain embodiments, subscriptions may automatically renew based upon an action or inaction of a subscriber or end user. In certain embodiments, a virtual subscription may be accomplished without formal agreement among the affected parties, e.g., by selling a razor that requires use of specific blades.

Tag—A code embedded within an markup language-based electronic file which associates one or more words or images within the document with a Uniform Resource Locator (URL) corresponding to another file. Within the art, a tag of this particular functionality may be referred to as an “HREF” (hypertext reference) tag.

Transaction—includes any communication or agreement between two or more entities, including end users, individuals, retailers, and/or computing systems. In certain embodiments a transaction can include a financial transaction wherein a seller sells and item and a buy buys an item, where such seller may experience an increase in finances while the buyer's finances may decrease. In certain embodiments, a transaction may include a communication between a computing system and an one or more end users, or between two computing systems, a computing system and a database or data repository, two end users, two or more data repositories, etc. In additional embodiments, a transaction includes a POS transaction, where a customer places and pays for one or more items, goods, services, or products and/or access to or use of any or all of the foregoing, and/or via a website and/or using a POS terminal or POS device.

User—includes any entity or person including a person making use or practicing the various disclosed embodiments of the invention. The terms user and end user shall include corollary meanings.

User-Visible Text Portion—A portion of markup language-based code which specifies the text or other images to be displayed to a Web user. An example (in bold) as well as the corresponding tag (underlined) follows: Ex. <A HREF=“http://go.msn.com/npl/msnt.asp”target=“_top”><IMG SRC=“/chan/home/logo.gif” WIDTH=140 HEIGHT=60 BORDER=0 ALT=“Go to msn.com”>Microsoft Network</A>

Web Browser—A client application that enables a user to view markup language-based documents on the World Wide Web, another network, or the user's computer; utilize the hyperlinks among the documents, as well as transfer and execute files within the documents.

Web Site—A subset of the World Wide Web comprising a collection of files, documents and graphics made generally available to others through the Internet. In certain embodiments a web site may include means for conducting a transaction, including, for example, a POS transaction.

Wireless Communications Device (WCD)—A communications device that transceives via a non-wired medium, such as radio frequency. A WCD can include, but is not limited to an AM or FM radio device, a television, cell phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, and 3G.

World Wide Web—The total set of inter-linked hypertext documents residing on Hypertext

Computing. It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. A “processor” means one or more microprocessors, central processing units (CPUs), computing devices, microcontrollers, digital signal processors, or like devices or any combination thereof.

A description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software or hardware only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

Remote Connectivity means any method used by a Controller, a Display or a Server or other computing devices to communicate with other devices or networks including, but not limited to the Internet, Satellite networks, Cell Phone networks, other wireless networks and standards such as 802.11, 80211.b, 802.11g, or similar wireless LAN operating standards, or Bluetooth technologies, infrared connections, or any other similar technologies or other technologies such as those described above that permit the sending and/or receiving and/or processing of electronic information in either an encrypted or unencrypted format.

Server means one or more computing systems that include at least one of a processor, computer readable medium, or input/output capabilities and may have local or Remote Connectivity capabilities. Servers may be local or remote to Displays or both. A Server may be or include one or more of a Display and/or a Controller.

In an embodiment, a Server computer or centralized authority may not be necessary or desirable. For example, the present invention may, in an embodiment, be practiced on one or more devices without a central authority. In such an embodiment, any functions described herein as performed by the Server computer or data described as stored on the Server computer may instead be performed by or stored on one or more such devices.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining, recognizing, and the like. A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors. The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present disclosure, but may nevertheless be claimed in one or more continuing applications that claim the benefit of priority of the present disclosure.

It will, of course, be understood that the foregoing description is of exemplary embodiments of the invention and that the invention is not limited to the specific embodiments shown. Various changes and modifications will become apparent to those skilled in the art and all such variations and modifications are intended to come within the spirit and scope of the appended claims.

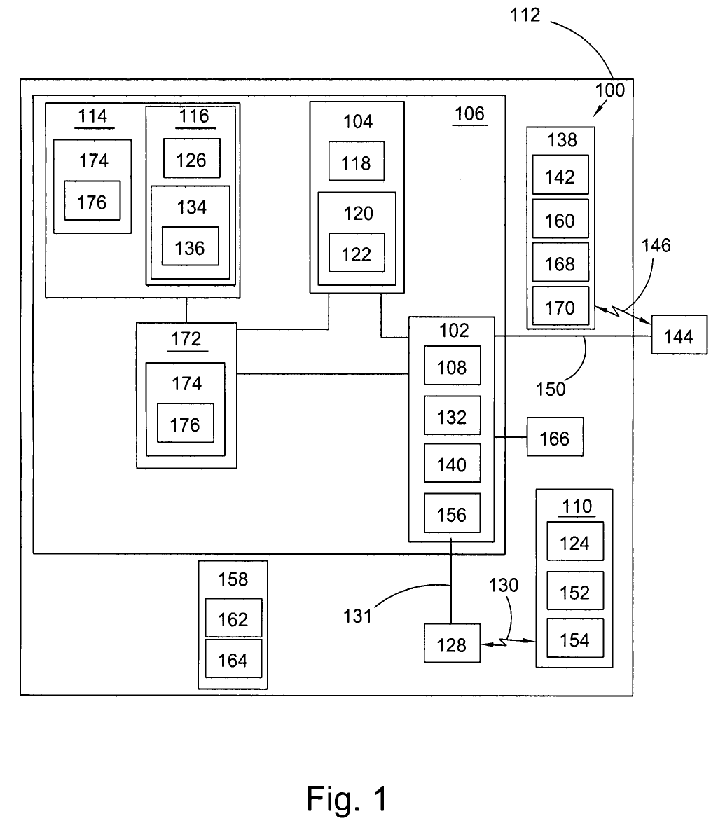

FIG. 1 is a schematic diagram of present invention system 100 for automated return of an item. System 100 includes interface element 102 and processor 104 in specially programmed general-purpose computer 106. Element 102 is arranged to automatically receive detection signal 108 regarding item 110 when item 110 is brought within a predetermined proximity of retail location 112 operated by a business entity (not shown). Item 110 was previously purchased from the business entity by a customer (not shown). By automatically, we mean that the detection is performed without human intervention, that is, the hardware, firmware, and software in system 100 are configured and programmed to perform the detection without further guidance. In some aspects, the predetermined proximity is within the physical bounds of a building housing the retail location. By retail location, we mean a location where goods are offered for sale and are kept on hand for dispersal to customers. Goods can be offered by any pricing structure known in the art, for example, goods can be offered at manufacturer's list prices available to the general public or can be offered at wholesale prices only available to prospective customers meeting certain requirements. By interface element, we mean any combination of hardware, firmware, or software in a computer used to enable communication or data transfer between the computer and a device, system, or network external to the computer. Computer 106 can be any computer or combination of computers known in the art. Processor 104 and interface element 102 can be any processor or interface element, respectively, or combination thereof, known in the art. The interface element can connect with the device, system, or network external to the computer using any means known in the art, including, but not limited to a hardwire connection, an optical connection, an Internet connection, or a radio frequency connection. In the figures, non-limiting examples of hardwire connections are shown.

System 100 includes memory element 114 having sales data 116 for items purchased from the retail location. The processor includes identification element, or function, 118 and credit element, or function, 120. Alternately stated, elements 118 and 120 and any other elements described as being in the processor are functions of the processor or are functions carried out by the processor. Element 118 is arranged to determine, or confirm, using sales data 116 and detection signal 108, that item 110 was previously purchased from the business entity by the customer and the credit element is arranged to apply credit 122 for item 110 to an account (not shown) associated with the customer. Element 120 can determine an amount of the credit by any means known in the art. For example, in some aspects, data 116 includes the original purchase price for the item, element 120 accesses the data, and the credit is equal to the original purchase price.

In some aspects, item 110 includes radio frequency identification (RFID) tag 124 and sales data 116 includes sales record 126 for item 110, which in turn includes data regarding RFID tag 124. System 100 is arranged to detect tag 124 using any means known in the art, for example, RFID transceiving, or detecting, unit 128. Unit 128 is arranged to transmit and receive radio frequency (RF) signal 130, to and from, respectively, tag 124. Unit 128 is connected to connect to interface element 102 using any means known in the art, for example, hard wire connection 131. The receiving portion of signal 130 includes data 132 identifying the tag, as is known in the art. The interface element receives data 132 and identification element 118 is arranged to use data 132 to select sales record 126. That is, sales record 126 is linked to identification data 132.

In some aspects, sales data 116 includes sales record 134 for item 110. Record 134 includes data 136 regarding wireless communications device 138 associated with the customer. By associated with the customer, we mean that the device is owned by the customer, registered to the customer, or otherwise linked to the customer such that identification of the device enables authorized identification of the customer. Interface element 102 is arranged to receive detection signal 140 for the wireless communications device when the wireless device is within a predetermined proximity of the retail location. In some aspects, the predetermined proximity is within the physical bounds of the building housing the retail location, for example, near an entrance to the building. In some aspects, the predetermined proximity is the same as that described supra. The detection signal can be generated using any means known in the art. For example, in some aspects device 138 includes a global positioning system (GPS) device (not shown) and the GPS device is accessed to ascertain the position of device 138. In one embodiment, device 138 is connectable to a docking station (not shown), for example, a docking station on a shopping cart, to enable device 138 to establish communication with system 100. Any docking station or docking means known in the art can be used. That is, when the device is connected to the docking station, a link is established between the device and system 100. The docking station is interfaced with element 102 via a wireless connection.

In one embodiment, the wireless communications device is arranged to obtain data 142 identifying item 110, from item 110. The interface element is arranged to receive data 142 from the wireless communications device using any means known in the art. In some aspects, device 138 is a cell phone in communication with cell phone network 144 via RF signal 146 and the network is in communication with interface element 102 via hardwire connection 150. Identification element 118 is arranged to use data 142 to select sales record 134.

Device 138 can obtain data 142 using any means known in the art. For example, in some aspects item 110 has one or both of RFID tag 152 and bar code 154 and device 138 is equipped to detect the tag, for example, by using an on-board camera (not shown) or to scan the bar code using a bar code scanner (not shown) on the camera. In some aspects, the credit element is arranged to apply the credit for item 110 to an account (not shown) for the wireless communications device.

In some aspects, when the customer has a membership (not shown) with one of a loyalty program and a marketing program (not shown), the credit element is arranged to apply the credit for item 110 to the account associated with the membership.

In some embodiments, only certain items can be returned, for example, only items that have not been previously opened. Determination of whether an item has been opened or otherwise used may be made via any applicable means, including manual inspection methods at the time or generally near the time or some other subsequent time of the return. In some aspects, credit element 120 is arranged to defer issuance of credit 122 until a satisfactory condition of item 110 is confirmed. Such confirmation can be obtained in any manner known in the art. In some aspects, the confirmation is performed automatically, per the description of ‘automatically’ provided supra. For example, in some aspects item 110 includes RFID tag 152. Tag 152 is arranged in or on item 110 such that a condition of the tag provides information as to whether item 110 has been opened or is otherwise intact. System 100 is arranged to detect tag 152 using any means known in the art, for example, in some aspects, RFID transceiving, or detecting, unit 128 described supra is used. In these aspects, data 156 regarding the condition of tag 152 is received at unit 128 via RF signal 130 and data 156 is transmitted to element 102 via connection 131. For example, RFID tag 152 can be configured in packaging material for item 110 and positioned in such a way that, when item 110 is opened, the RFID tag is destroyed or is otherwise rendered non-functioning. Credit element 120 uses data 156 to determine whether or how to apply credit 122. For example, if data 156 shows item 110 has not been opened or is otherwise satisfactorily intact, credit element 120 issues credit 122. Conversely, if data 156 shows item 110 has been opened or is otherwise not satisfactorily intact, credit element 120 defers the issuance of the credit and system 100 issues a communication to the customer and/or retail location personnel. For example, the communication could instruct the personnel to manually inspect the item or could instruct the customer to contact the retail location or business entity. In some aspects, tags 124 and 152 are the same. In some aspects, any anti-theft device or system (not shown), known in the art can be used with item 110 and connected to interface element 102 to determine a condition of the item.

If a credit has been issued and it is subsequently determined that the item has been opened, used, damaged or is otherwise ineligible for return, such credit may be rejected and/or the customer can be notified to return to the retail location to address the issue.

In some embodiments, only exchanges for item 110 are enabled in system 100. Such exchanges can be subject to the verification/inspection procedures described supra.

In some aspects, system 100 enables a customer to obtain replacement item 158 for item 110. In some aspects, credit element 120 applies credit 122, which has a value based on the price paid for item 110, against the cost of the replacement item. In some aspects, device 138 obtains data 160 regarding the replacement item as described supra, for example, from RFID tag 162 or bar code 164 on the replacement item. Then data 160 is transmitted to interface element 102 via connection 150 and credit element 120 uses data 160 as noted supra. In some aspects, if the cost of the replacement item exceeds the value of credit 122, credit element 120 accesses the accounts noted supra to apply a further charge, based on the difference between the cost and the value.

In some aspects, system 100 includes self-service identifying device 166 connected to interface element 102. By self-service, we mean that device 166 is usable by the customer to select an item for sale in the retail location and record the item in system 100 without intervention by or assistance from personnel of the retail location. Device 166 can be any such device known in the art. For example, device 166 can read RFID tags or can be a bar code scanner. Further, device 166 can be fixed, for example, at a kiosk (not shown) or can be portable, for example, mounted to a shopping cart (not shown). In some aspects, device 138 includes one or both of RFID tag 168 and bar code 170. The tag and bar code are correlated to the customer, for example, through data 136. The bar code could be in the form of a UPC label on the device or could be displayed on a GUI for the device.

To obtain item 158 as a replacement for item 110, the customer uses device 166 to read tag 162 or code 164 and tag 168 or code 170, the information in the respective tags and codes is transmitted to processor 104 and memory element 114 via the interface element. System 100 correlates the customer to the purchase of item 158 through the information from tag 168 or code 170 and credit element 120 processes credit 122 as described supra.

In some aspects, wireless communications device 138 includes a means (not shown) for detecting an RFID tag or a bar code. To obtain item 158 as a replacement for item 110, the customer uses device 138 to read tag 162 or code 164, the information in the tag or code is transmitted to processor 104 and memory element 114 via the interface element. System 100 correlates the purchase of item 158 to the customer via device 138 and credit element 120 processes credit 122 as described supra.

Thus, system 100 enables a customer to return an item and purchase a replacement item using devices available to the customer, for example, device 138, without the necessity of the customer interacting with store personnel and the possible delay and inconvenience attendant with such interaction.

In some aspects, system 100 includes compiler element 172 arranged to compile transaction history 174 for the customer and to store the history in memory element 114. Data for history 174 can be obtained by any means known in the art, for example, by monitoring system 100 or by accessing other systems (not shown) through interface element 102. Transaction history 174 includes data 176 regarding items (not shown) previously returned by the customer. In some aspects, the credit element is arranged to apply credit 122 responsive to the transaction history. Thus, system 100 is able to compile and evaluate information regarding previous actions taken by the customer and to modify actions taken by the system accordingly. For example, history 172 could show that the customer has a history of ‘gaming’ or other undesirable activities intended to exploit system 100. If such activities are detected, system 100 can instruct credit element 120 to withhold credit 122 until personnel at the retail location can meet with the customer or otherwise determine the legitimacy of the action being taken by the customer.

Thus, by tracking customer return behavior and by tracking the frequency or percentage of such returns that are determined as approved or valid, system 100 can determine that certain customers are more or less prone to ‘gaming’ or other undesirable actions, such as returning used or damaged items and provide a safeguard against such customers. For example, the system can determine: which customer return items should be inspected; which customer returns should be inspected more fully or rejected outright; or which customers may or may not continue to use system 100 for returns.

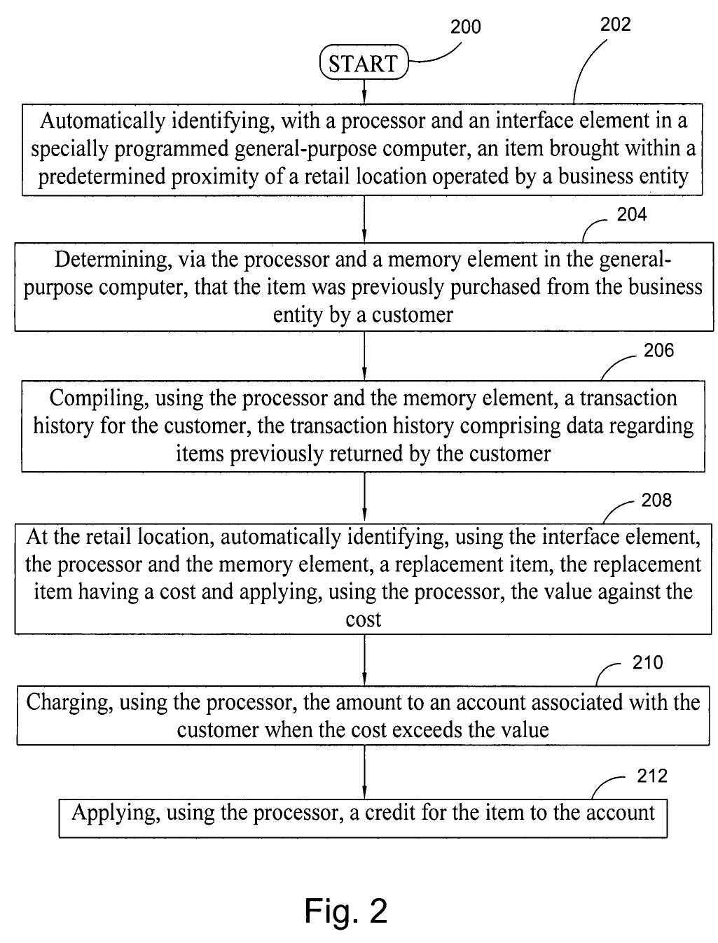

FIG. 2 is a flow chart illustrating a present invention method for automated return of an item. Although the method in FIG. 2 is depicted as a sequence of numbered steps for clarity, no order should be inferred from the numbering unless explicitly stated. The method starts at Step 200. Step 202 automatically identifies, with a processor and an interface element in a specially programmed general-purpose computer, an item brought within a predetermined proximity of a retail location operated by a business entity. Step 204 determines, via the processor and a memory element in the general-purpose computer, that the item was previously purchased from the business entity by a customer. Step 212 applies, using the processor, a credit for the item to an account associated with the customer.

In some aspects, the item includes a radio frequency identification (RFID) tag and the memory element includes a sales record for the item includes data regarding the RFID tag. Then, step 202 automatically detects the RFID tag and transmits data identifying the RFID tag to the interface element, and step 204 uses the data identifying the RFID tag to select the sales record. In some aspects, the memory element includes a sales record for the item includes data regarding a wireless communications device associated with the customer and step 202: detects the wireless communications device within the predetermined proximity of the retail location; obtains, with the wireless communications device, data identifying the item; and receives in the interface element, the data identifying the item. Then, step 204 uses the data identifying the item to select the sales record.

In some aspects, the wireless communications device includes a means for detecting at least one of an RFID tag and a bar code, the item includes one of an RFID tag and a bar code and step 202 detects the RFID or scans the bar code using the means for detecting at least one of an RFID tag and a bar code. In some aspects, step 212 applies the credit to an account for the wireless communications device. In some aspects, the customer has a membership with a loyalty program or a marketing program and step 212 applies the credit to an account associated with the membership.

In some aspects, step 212 withholds the credit until a satisfactory condition of the item is confirmed. In some aspects, the item includes an RFID tag and confirming a satisfactory condition of the item includes determining a condition of the RFID tag. In some aspects, the item includes an anti-theft element and confirming a satisfactory condition of the item includes automatically evaluating the anti-theft element. In some aspects, step 206 compiles, using the processor and the memory element, a transaction history for the customer, the transaction history includes data regarding items previously returned by the customer and step 212 applies the credit responsive to the transaction history.

In some aspects, the credit includes a value and step 208, at the retail location, automatically identifies, using the interface element, the processor, and the memory element, a replacement item, the replacement item having a cost and applies, using the processor, the value against the cost. In some aspects, the cost exceeds the value by an amount and step 210 charges, using the processor, the amount to the account. In some aspects, a wireless communications device associated with the customer and the replacement item each include an RFID tag or a bar code and automatically identifying a replacement item in step 202 includes detecting the respective RFID tag or bar code for the wireless communications device and the replacement item with a self-service device in the retail location. In some aspects, a wireless communications device associated with the customer includes a means for detecting an RFID tag or a bar code and the replacement item includes an RFID tag or a bar code. Then, automatically identifying a replacement item in step 202 includes detecting the RFID tag or the bar code for the replacement item with the wireless communications device.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method for automated return of an item, comprising the steps of:
automatically identifying, with a processor and an interface element in a specially programmed general-purpose computer, an item brought within a predetermined proximity of a retail location operated by a business entity;
determining, via said processor and a memory element in said general-purpose computer, that said item was previously purchased from said business entity by a customer; and,
applying, using said processor, a credit for said item to an account associated with said customer.

2. The method of claim 1 wherein said item comprises a radio frequency identification (RFID) tag and said memory element comprises a sales record for said item comprising data regarding said RFID tag, wherein automatically identifying an item further comprises automatically detecting said RFID tag and transmitting data identifying said RFID tag to said interface element, and wherein determining that said item was previously purchased further comprises using said data identifying said RFID tag to select said sales record.

3. The method of claim 1 wherein said memory element comprises a sales record for said item comprising data regarding a wireless communications device associated with said customer and wherein automatically identifying an item further comprises:
detecting the wireless communications device within said predetermined proximity of said retail location;
obtaining, with said wireless communications device, data identifying said item; and,
receiving in said interface element, said data identifying said item and wherein determining that said item was previously purchased further comprises using said data identifying said item to select said sales record.

4. The method of claim 3 wherein said wireless communications device comprises a means for detecting at least one of an RFID tag and a bar code, wherein said item comprises one of an RFID tag and a bar code, and wherein obtaining, with said wireless communications device, data identifying said item further comprises one of detecting said RFID and scanning said bar code for said item using said means for detecting at least one of an RFID tag and a bar code.

5. The method of claim 3 wherein applying a credit further comprises applying said credit to an account for said wireless communications device.

6. The method of claim 1 wherein said customer has a membership with one of a loyalty program and a marketing program and wherein applying a credit further comprises applying said credit to an account associated with said membership.

7. The method of claim 1 wherein applying a credit further comprises withholding said credit until a satisfactory condition of said item is confirmed.

8. The method of claim 7 wherein said item comprises an RFID tag and wherein confirming a satisfactory condition of said item comprises automatically determining a condition of said RFID tag.

9. The method of claim 7 wherein said item comprises an anti-theft element and wherein confirming a satisfactory condition of said item comprises automatically evaluating said anti-theft element.

10. The method of claim 1 wherein said credit comprises a value and said method further comprising:
at said retail location, automatically identifying, using said interface element, said processor, and said memory element, a replacement item, said replacement item having a cost; and,
applying, using said processor, said value against said cost.

11. The method of claim 10 wherein a wireless communications device associated with said customer and said replacement item each comprise one of an RFID tag and a bar code and wherein automatically identifying a replacement item further comprises, detecting said one of an RFID tag and a bar code for each of said wireless communications device and said replacement item with a self-service device in said retail location.

12. The method of claim 10 wherein a wireless communications device associated with said customer comprises a means for detecting at least one of an RFID tag and a bar code, wherein said replacement item comprises one of an RFID tag and a bar code, and wherein automatically identifying a replacement item further comprises, detecting said one of an RFID tag and a bar code for said replacement item with said wireless communications device.

13. The method of claim 10 wherein said cost exceeds said value by an amount and said method further comprising charging, using said processor, said amount to said account.

14. The method of claim 1 further comprising compiling, using said processor and said memory element, a transaction history for said customer, said transaction history comprising data regarding items previously returned by said customer and wherein applying a credit further comprises applying said credit responsive to said transaction history.

15. A system for automated return of an item, comprising:
an interface element for a specially programmed general-purpose computer arranged to receive a detection signal regarding an item when said item is within a predetermined proximity of a retail location operated by a business entity;
a memory element in said general-purpose computer comprising sales data for items purchased from said retail location;
an identification element in a processor for said general-purpose computer arranged to determine, using said sales data and said detection signal, that said item was previously purchased from said business entity by a customer; and,
a credit element in said processor, arranged to apply a credit for said item to an account associated with said customer.

16. The system of claim 15 wherein said item comprises a radio frequency identification (RFID) tag and said memory element comprises a sales record for said item comprising data regarding said RFID tag, said system further comprising an RFID transceiving unit arranged to detect said RFID tag and to transmit data identifying said RFID tag to said interface element, and wherein said identification element is arranged to use said data identifying said RFID tag to select said sales record.

17. The system of claim 15 wherein said memory element comprises a sales record for said item comprising data regarding a wireless communications device associated with said customer, wherein said interface element is arranged to receive a detection signal for said wireless communications device when said wireless device is within said predetermined proximity of said retail location, wherein said wireless communications device is arranged to obtain data identifying said item from said item, wherein said interface element is arranged to receive said data identifying said item from said wireless communications device, and wherein said identification element is arranged to use said data identifying said item to select said sales record.

18. The system of claim 17 wherein said item comprises one of an RFID tag and a bar code and wherein said wireless communications device is arranged to obtain said data identifying said item from said one of said RFID tag and said bar code.

19. The system of claim 17 wherein said credit element is arranged to apply said credit to an account for said wireless communications device.

20. The system of claim 15 wherein said customer has a membership with one of a loyalty program and a marketing program and wherein said credit element is arranged to apply said credit to an account associated with said membership.

21. The system of claim 15 wherein said credit element is arranged to withhold said credit until a satisfactory condition of said item is confirmed.

22. The system of claim 21 wherein said item comprises an RFID tag and wherein said interface element is arranged to receive an automatic signal regarding a condition of said RFID tag to determine a condition of said item.

23. The system of claim 21 wherein said item comprises an anti-theft element and wherein said interface element is arranged to receive an automatic signal regarding a condition of said anti-theft element to determine a condition of said item.

24. The system of claim 15 wherein said credit comprises a value and wherein said processor further comprises a replacement element arranged to identify, using said interface element and said memory element, a replacement item, said replacement item having a cost and wherein said credit element is arranged to apply said value against said cost.

25. The system of claim 24 wherein said cost exceeds said value by an amount and said credit element is arranged to charge said amount to said account.

26. The system of claim 24 further comprising a self-service identifying device and wherein a wireless communications device associated with said customer and said replacement item each comprise one of an RFID tag and a bar code and said self-service identifying device is arranged to detect said one of an RFID tag and a bar code for each of said wireless communications device and said replacement item to identify said item.

27. The system of claim 24 wherein said replacement item comprises one of an RFID tag and a bar code, wherein a wireless communications device associated with said customer comprises a means for detecting at least one of an RFID tag and a bar code, and wherein said interface element is arranged to receive a signal including information from said at least one of an RFID tag and a bar code for said replacement item from said wireless communications device to identify said item.

28. The system of claim 15 wherein said processor comprises a compiler element arranged to compile a transaction history for said customer and to store said history in said memory element, said transaction history comprising data regarding items previously returned by said customer and wherein said credit element is arranged to apply said credit responsive to said transaction history.
